(19) United States
(12) Patent Application Publication
(10) Pub. No.: US 2014/0251150 A1
(43) Pub. Date: Sep. 11, 2014

(54) Stackable brewing hoppers

(71) Applicant: Richard Allen Vessey, Olympia, WA (US)

(72) Inventor: Richard Allen Vessey, Olympia, WA (US)

(21) Appl. No.: 13/815,464

(22) Filed: Mar. 6, 2013

(51) Int. Cl. A47J 31/44

(52) U.S. Cl. CPC A47J 31/4403
USPC 99/289 R

(57) ABSTRACT

A stackable beverage producer that has a upper hopper (15) and a lower hopper (32) that can be stacked on top of each other to create separate chambers. The upper hopper (15) has a flavor adjustment valve (16) and the lower hopper (32) has a flavor adjustment valve (33) that is attached near the drain holes which can be adjusted to open or close up the drain holes to any size of diameter to increase or decrease the strength and flavor of a finished flavored beverage (49) produced by using a liquid and food products. The lower hopper (32) has a breather trough (36) which is a recessed area generally located on the bottom of the lower hopper (32) so that it can fit onto various sizes of receptacles (48) making it universal to many applications. The stackable beverage producer further comprising a removable lid (11) that has a hole (14) generally located in the middle of the lid (11) with a lid hole cover (12) that can open or close the hole (14) to any size of diameter, and a removable base (46) that is used in the storage mode.

### CROSS-REFERENCE TO RELATED APPLICATIONS

Not Applicable

### STATEMENT REGARDING FEDERALLY SPONSERED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of flavored beverage producers. More particularly, the present invention is in the technical field of a device used to increase or decrease the strength and flavor of a finished flavored beverage.

There are allot of different flavored beverages in the stores, but I never found one that I liked. It's either too sweet, not sweet enough, not enough flavor, too strong of a flavor, etc. There are only certain flavors made and some use artificial flavors and preservatives so you can never be sure how long it's been on the shelf or how fresh it is.

### BRIEF SUMMARY OF THE INVENTION

Thus several advantages of one or more aspects of the present invention is that the consumer can produce any finished flavored beverage that the consumer desires, at what strength and flavor the consumer desires, with no artificial flavors or preservatives.

Another object of this invention to be able to produce an inexpensive way of making a fresh finished flavored beverage at home.

These and other advantages of one or more aspects will be apparent from a consideration of the ensuing detailed description and accompanying drawings.

### BRIEF DESCRIPTION OF THE SEVERAL VIEWS OF THE DRAWINGS

The invention may take physical form in parts that are shaped differently and attached differently, a preferred embodiment is now made to the accompanying drawings wherein:

FIG. 1 is a perspective view of one version of the stackable brewing hoppers in storage mode;

FIG. 2 is a perspective view of one way the stackable brewing hoppers can be used;

FIG. 3A is an exploded bottom view of the upper hopper;

FIG. 3B is a perspective bottom view of FIG. 3A assembled;

FIG. 4A is an exploded bottom view of the lower hopper;

FIG. 4B is a perspective bottom view of FIG. 4A assembled;

FIG. 5A is a bottom view of FIG. 3B with the upper hopper flavor adjustment valve open and showing how it can be adjusted to close;

FIG. 5B is a bottom view of FIG. 3B with the upper hopper flavor adjustment valve closed part way and showing how it can be adjusted to open;

FIG. 6A is a bottom view of FIG. 4B with the lower hopper flavor adjustment valve open and showing how can be adjusted to close;

FIG. 6B is a bottom view of FIG. 4B with the lower hopper flavor adjustment valve closed part way and showing how it can be adjusted to open;

FIG. 7A is a top view of the removable lid with the lid hole cover open and showing how it can be adjusted to close;

FIG. 7B is a top view of the removable lid with the lid hole cover closed and showing how it can be adjusted to open;

FIG. 8 is a perspective view of the removable base; and

FIG. 9 is a top view of the removable screen.

### DETAILED DISCRIPTION OF THE INVENTION

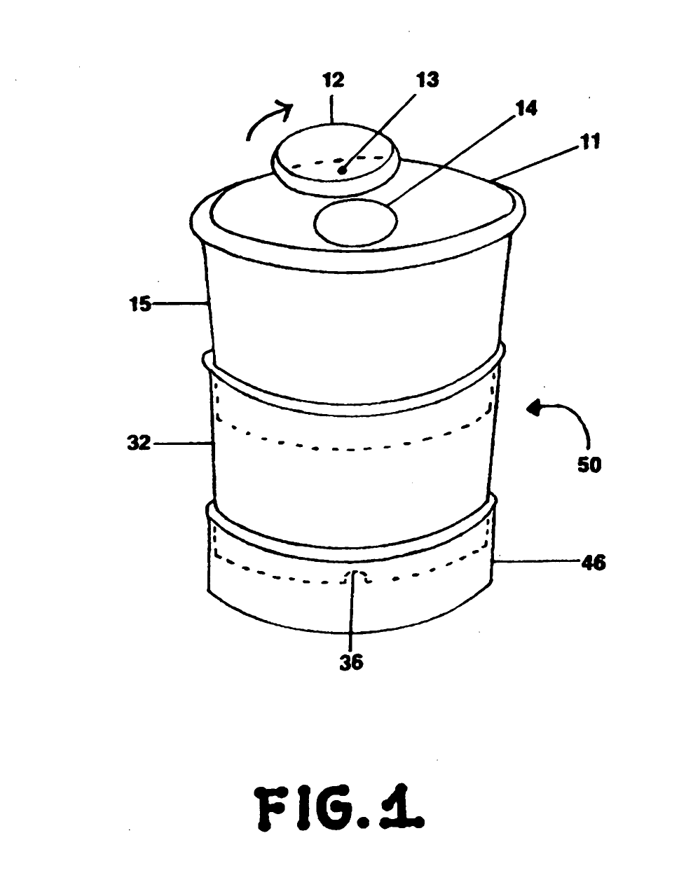

Referring now to the drawings wherein the showings are for the purpose of illustrating a preferred embodiment of the present invention only and not for the purpose of limiting same, FIG. 1 shows a preferred embodiment of one version of the stackable brewing hoppers 50 in storage mode. Stackable brewing hoppers 50 generally comprises of a upper hopper 15 a lower hopper 32 and a removable lid 11. A removable base 46 is used in the storage mode as seen in FIG. 1. Lid 11 has a lid hole 14 generally located in the middle of lid 11. There is a lid hole cover 12 which can be adjusted to close up hole 14. Cover 12 is attached to lid 11 by a fastening device 13. Lid 11 is placed on top of upper hopper 15. Upper hopper 15 is placed on lower hopper 32 then it is placed on base 46 to store away for a later use. A breather trough 36 is generally located on the bottom of lower hopper 32.

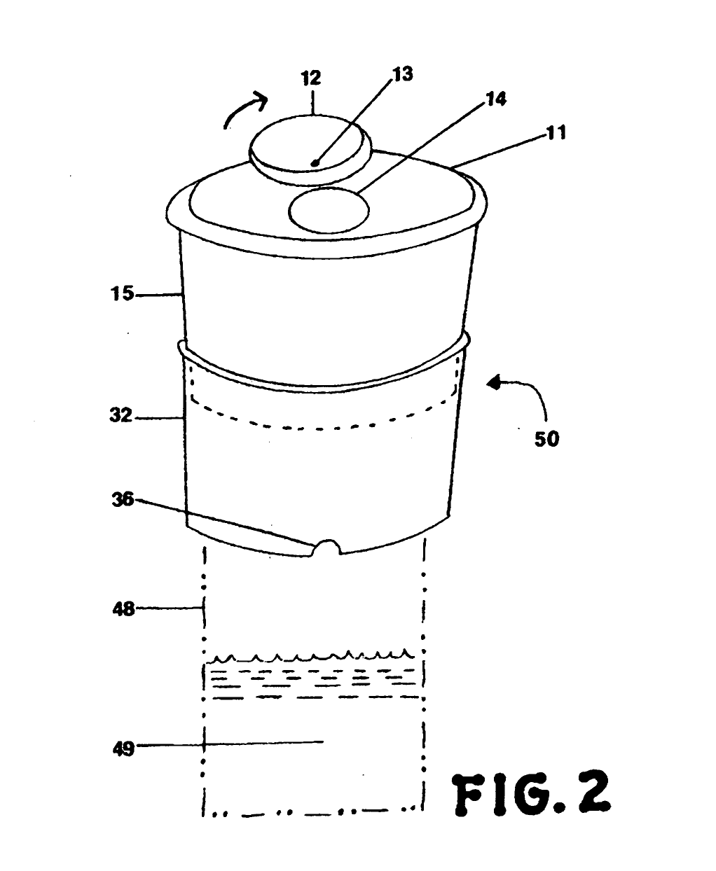

Referring now to FIG. 2 showing one way stackable brewing hoppers 50 can be used. Lid 11 has hole 14 with cover 12 attached to lid 11 by a fastening device 13 sits on top of upper hopper 15 which gets stacked on lower hopper 32. Stackable brewing hoppers 50 sits on top of a receptacle 48 that can receive a finished flavored beverage 49. Upper hopper 15 and lower hopper 32 have a cavity that is suitable for accepting tea, coffee or other food products and are generally sloped inward on the sides. Breather trough 36 which is a recessed area of a predetermined depth and length is generally located on the bottom of lower hopper 32 and prevents lower hopper 32 from sealing to receptacle 48.

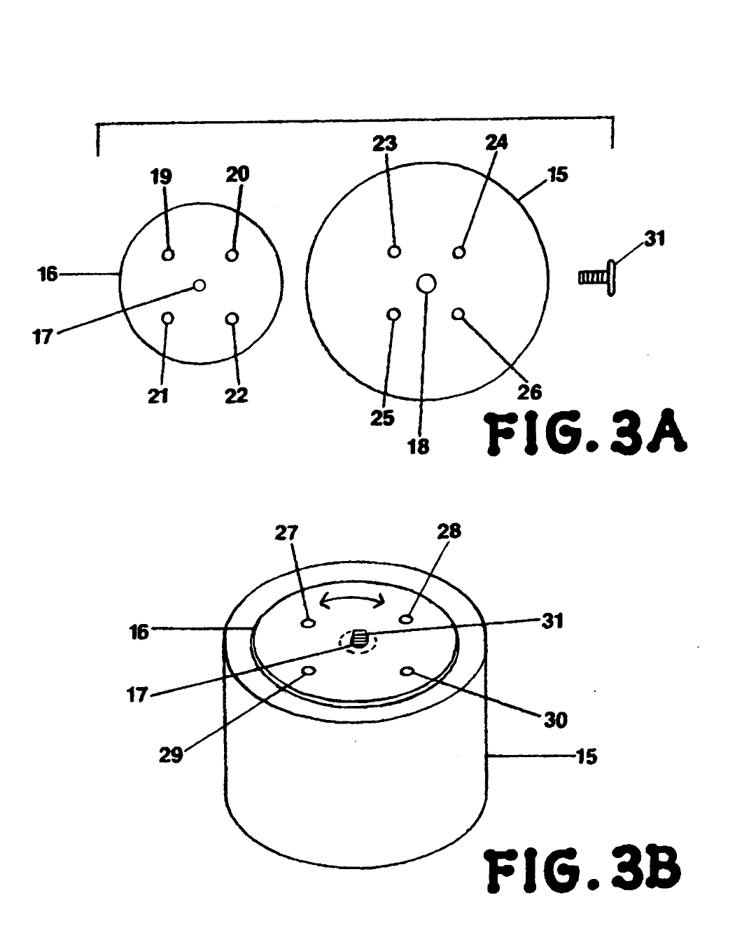

Referring now to FIG. 3A which is an exploded bottom view of upper hopper 15. Upper hopper 15 has drain holes 23, 24, 25 and 26 which lineup with drain holes 19, 20, 21 and 22 of a upper hopper flavor adjustment valve 16. Valve 16 has a threaded hole 17 which allows valve 16 to be mounted to the bottom of upper hopper 15 by the threads of a threaded bolt 31 being pushed through a upper hopper alignment hole 18 and screwed into threaded hole 17. The head of threaded bolt 31 stays on the inside of upper hopper 15 as shown in FIG. 3B

Referring now to FIG. 3B which is a perspective bottom view of FIG. 3A assembled. When valve 16 is mounted to the bottom of upper hopper 15 by bolt 31 screwing into threaded hole 17 of valve 16 drain holes 27, 28, 29 and 30 are lined up and can be adjusted to any size of diameter. Drain holes 27, 28, 29, 30 are valve 16 drain holes 19, 20, 21, 22 and upper hopper 15 drain holes 23, 24, 25, and 26 put together. The bottom of upper hopper 15 is sloped inward to a flat spot where valve 16 is located. The head of bolt 31 sits on the inside of upper hopper 15 so that it can allow valve 16 to be adjusted but still create a seal against the bottom of upper hopper 15.

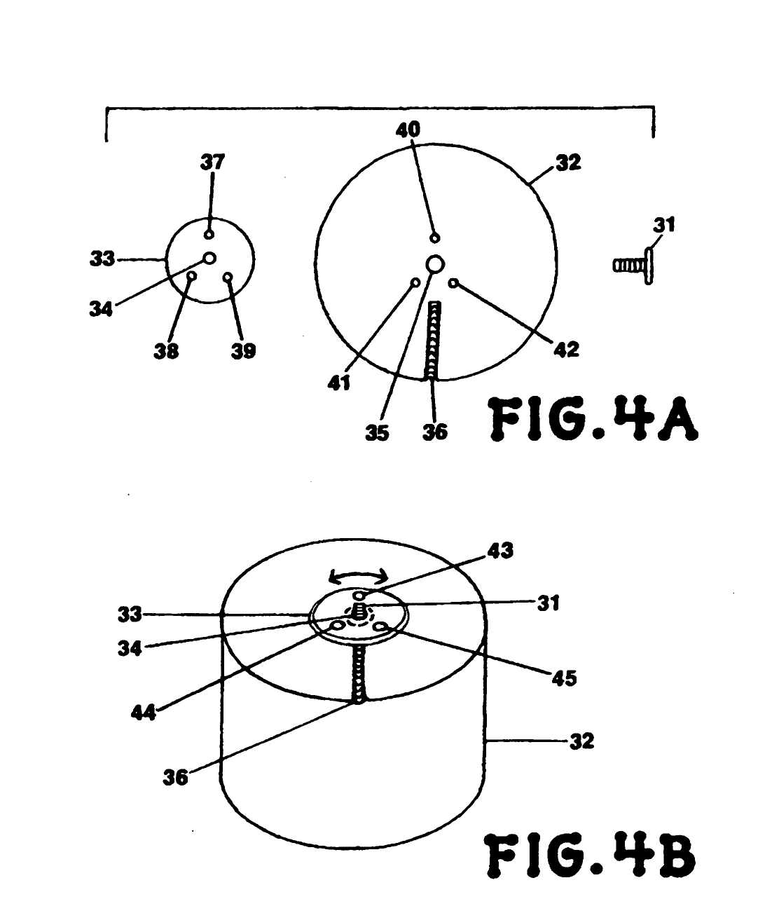

Referring to FIG. 4A which is an exploded bottom view of lower hopper 32. Lower hopper 32 has drain holes 40, 41 and 42 which line up with drain holes 37, 38 and 39 of a lower hopper flavor adjustment valve 33. Valve 33 has a threaded hole 34 which allows valve 33 to be mounted to the bottom of lower hopper 32 by the threads of bolt 31 being pushed through a lower hopper alignment hole 35 and screwed into threaded hole 34. The head of threaded bolt 31 stays on the inside of lower hopper 32 as shown in FIG. 4B. Lower hopper 32 has breather trough 36 which is a recessed area and is generally located on the bottom of lower hopper 32.

Referring now to FIG. 4B which is a perspective bottom view of FIG. 4A assembled. When valve 33 is mounted to the bottom of lower hopper 32 by bolt 31 screwing into threaded hole 34 of valve 33 drain holes 43, 44 and 45 are lined up and can be adjusted to any size of diameter. Drain holes 43, 44, 45 are valve 33 drain holes 37, 38, 39 and lower hopper 32 drain holes 40, 41, and 42 put together. The bottom of lower hopper 32 is sloped inward to a flat spot where valve 33 is located. The head of bolt 31 sits on the inside of lower hopper 32 so that it can allow valve 33 to be adjusted but still create a seal against the bottom of lower hopper 32. Lower hopper 32 has breather trough 36 which is a recessed area of a predetermined depth and length and is generally located on the bottom of lower hopper 32 from the outside edge of lower hopper 32 up to the outside edge of valve 33. This makes stackable brewing hoppers 50 adaptable to receptacle 48 of various sizes and shapes without causing a drainage problem.

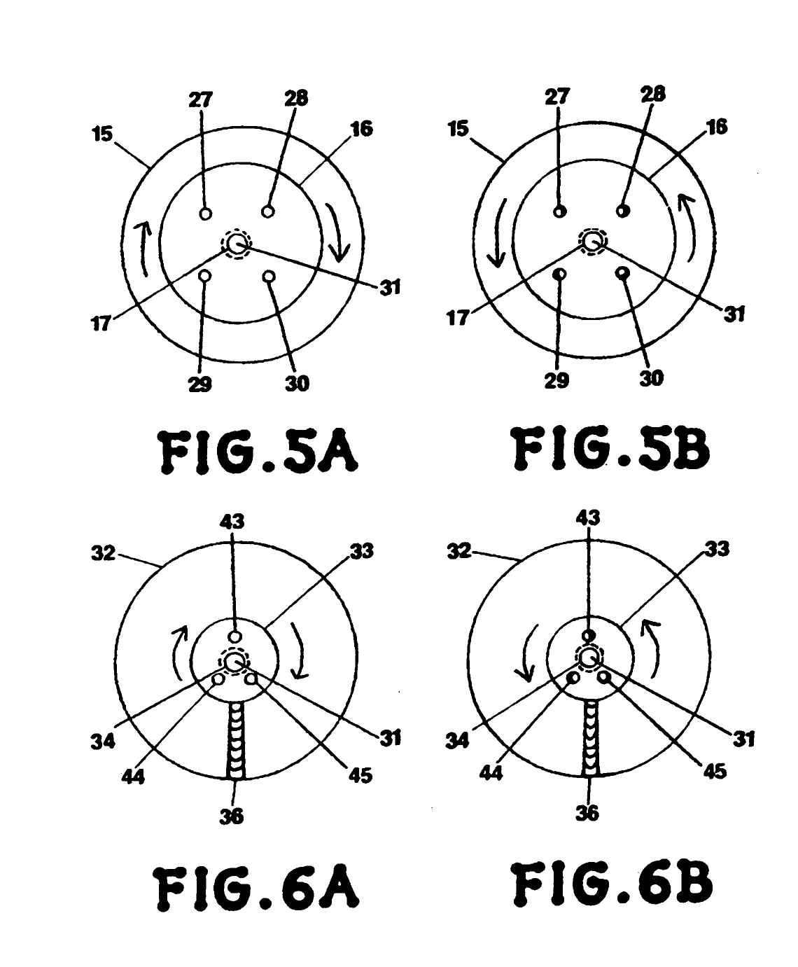

Referring to FIG. 5A and FIG. 5B which is a bottom view of FIG. 3B shows how valve 16 is mounted to the bottom of upper hopper 15 when bolt 31 is screwed into threaded hole 17 of valve 16 which creates drain holes 27, 28, 29 and 30. FIG. 5A illustrates one way that valve 16 can be adjusted so that drain holes 27, 28, 29 and 30 will close up to a predetermined size of diameter. FIG. 5B shows how valve 16 is closed part way and how valve 16 can be adjusted in the opposite direction so that drain holes 27, 28, 29 and 30 will open up to a predetermined size of diameter.

Referring to FIG. 6A and FIG. 6B which is a bottom view of FIG. 4B showing how valve 33 is mounted to the bottom of lower hopper 32 when bolt 31 is screwed into threaded hole 34 of valve 33 which creates drain holes 43, 44 and 45. FIG. 6A illustrates one way that valve 33 can be adjusted so that drain holes 43, 44 and 45 will close up to a predetermined size of diameter. FIG. 6B shows how valve 33 is closed part way and how valve 33 can be adjusted in the opposite direction so that drain holes 43, 44 and 45 will open up to a predetermined size of any diameter. FIG. 6A and FIG. 6B also shows breather trough 36 and how it might look if it was molded into the bottom of lower hopper 32.

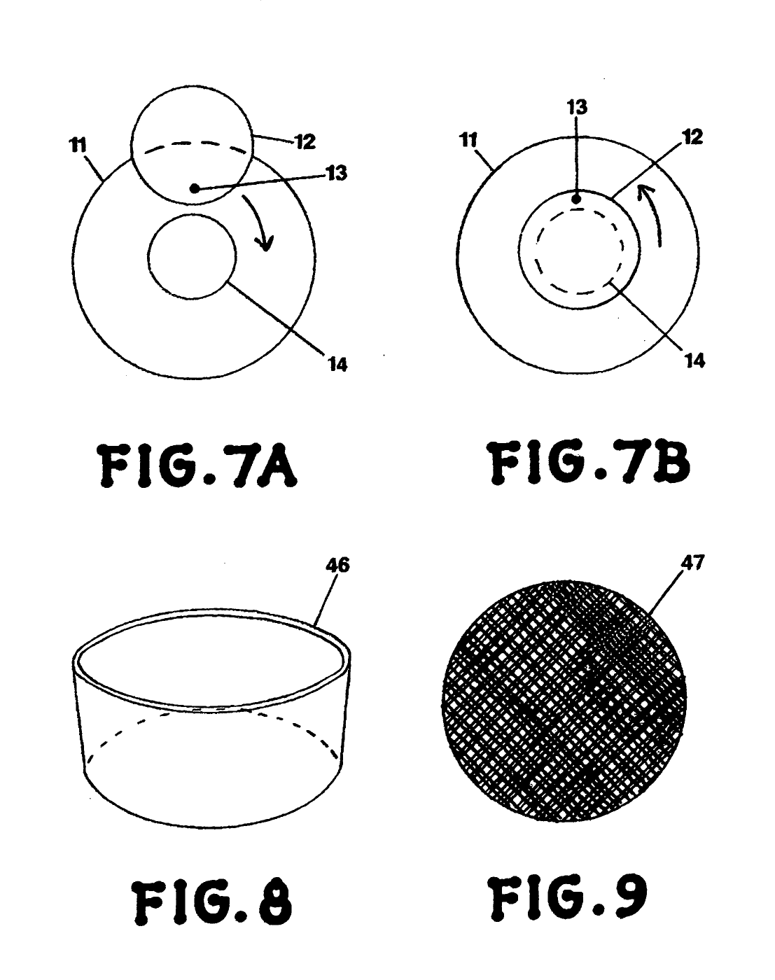

Referring to FIG. 7A and FIG. 7B which is a top view of lid 11 and how cover 12 is attached to lid 11 by fasting device 13 which lets it move. FIG. 7A shows hole 14 open and how cover 12 is adjusted to close hole 14 while FIG. 7B shows hole 14 closed and how cover 12 is adjusted to open hole 14. Cover 12 creates a seal on top of lid 11 when cover 12 is adjusted to the closed position as shown in FIG. 7B.

Referring to FIG. 8 which is a perspective view of base 46 and is used in the storage mode.

Now referring to FIG. 9 which is a perspective view of a removable screen 47 and can be used for smaller food products. It fits inside upper hopper 15 or lower hopper 32 depending on the size of food products used.

Referring now to the operation of stackable brewing hoppers 50. Valve 33 is adjusted to a predetermined size of diameter by the consumer and then lower hopper 32 is placed on top of receptacle 48. Tea, coffee or other food products are then placed inside of lower hopper 32 to a predetermined level. Then valve 16 is adjusted to a predetermined size of diameter by the consumer then upper hopper 15 is placed on top of lower hopper 32. Then tea, coffee, or other food products are placed inside upper hopper 15 to a predetermined level. Then place lid 11 on top of upper hopper 15 with hole 14 open. A liquid is then poured into hole 14 filling upper hopper 15 and then draining into lower hopper 32 which drains into receptacle 48 to create beverage 49.

The strength and flavor of beverage 49 is determined by the settings of valve 16 and valve 33 and the food products used. The more valve 16 is adjusted in a certain direction the more it closes up drain holes 27, 28, 29 and 30 which will create more soaking time of the food products used which will increase the strength and flavor of beverage 49. The less valve 16 is adjusted in a certain direction the more drain holes 27, 28, 29 and 30 will be opened which will create less soaking time of the food products use which will decrease the strength and flavor of beverage 49.

The more valve 33 is adjusted in a certain direction the more it closes up drain holes 43, 44 and 45 in which will create more soaking time of the food products use which will increase the strength and flavor of beverage 49. The less valve 33 is adjusted in a certain direction the more drain holes 43, 44 and 45 will be opened which will create less soaking time of the food products use which will decrease the strength and flavor of beverage 49.

There are allot of different varieties of strengths and flavors that the consumer can achieve with stackable brewing hoppers 50 just by adjusting valve 16 or valve 33. The consumer can close drain holes 27, 28, 29 and 30 to a very small size and then open up drain holes 43, 44 and 45 to a very big size so the consumer can increase the strength and flavor from the food products used in upper hopper 15 and decrease the strength and flavor from the food products used in lower hopper 32. If the strength and flavor of the beverage 49 is too strong from the food products used in upper hopper 15 then adjust valve 16 to open up drain holes 27, 28, 29 and 30 to create less soaking time which will decrease the strength and flavor of beverage 49. If the strength and flavor of finished flavored beverage 49 is too weak from the food products used in lower hopper 32 adjust valve 33 to close up drain holes 43, 44 and 45 to create more soaking time which will increase the strength and flavor of beverage 49.

Once the consumer finds the desired strength and flavor for beverage 49 and the liquid stops flowing out of drain holes 43, 44 and 45 then the consumer can attach base 46 to stackable brewing hoppers 50 as seen in FIG. 1 and store stackable brewing hoppers 50 away for a later use. When the consumer is ready to make more beverage 49 the consumer sets the stackable brewing hoppers 50 onto receptacle 48 and pours more liquid into hole 14 until the food products used are stale. Once the food products used become stale that were in upper hopper 15 and lower hopper 32 then the consumer can discard the stale food products into the trash and add fresh food products to upper hopper 15 and lower hopper 32 to create more beverage 49.

The preferred embodiment of the stackable brewing hoppers has been described with respect to the present invention. Modifications and alterations may change any part or parts of the preferred embodiment of the present invention such as different sizes, shapes, and materials used to make any part of the invention. It is intended that all such modifications and alterations be included insofar as they come within the scope of the patent as claimed or the equivalents thereof.

Thus, having described the invention in detail, I claim:

1. a stackable beverage producer comprising:
a upper hopper with a predetermined amount of drain holes at said upper hopper lowest point;
a lower hopper with a predetermined amount of drain holes at said lower hopper lowest point;
a removable lid that can be attached to said upper hopper or said lower hopper;
a removable base that can be attached to said upper hopper or said lower hopper;
a removable screen that fits inside of said upper hopper or said lower hopper.

2. The stackable beverage producer as defined in claim 1, wherein said upper hopper can be stacked on top of said lower hopper so that separate brewing chambers are created.

3. The stackable beverage producer of claim 1, wherein said drain holes of said upper hopper have a predetermined size of diameter.

4. The stackable beverage producer of claim 1, wherein said drain holes of said upper hopper has a flavor adjustment valve attached near said drain holes by means in which it will allow said flavor adjustment valve to be adjusted.

5. The stackable beverage producer of claim 4, wherein said flavor adjustment valve can be adjusted to open or close said drain holes of said upper hopper to any size of diameter from all the way opened to all the way closed and any size of diameter in between opened and closed.

6. The stackable beverage producer of claim 1, wherein said drain holes of said lower hopper have a predetermined size of diameter.

7. The stackable beverage producer of claim 1, wherein said drain holes of said lower hopper has a flavor adjustment valve attached near said drain holes by means in which it will allow said flavor adjustment valve to be adjusted.

8. The stackable beverage producer of claim 7, wherein said flavor adjustment valve can be adjusted to open or close said drain holes of said lower hopper to any size of diameter from all the way opened to all the way closed and any size of diameter in between opened and closed.

9. The stackable beverage producer of claim 1, wherein said lower hopper having a breather trough.

10. The stackable beverage producer of claim 9, wherein said breather trough is a recessed area of a predetermined depth and length generally located on the bottom of said lower hopper.

11. The stackable beverage producer of claim 1, wherein said lid has a predetermined size hole generally located in the middle of said lid.

12. The stackable beverage producer of claim 11, wherein said hole in said lid has a lid hole cover attached near said hole by means in which it will allow said lid hole cover to be adjusted.

13. The stackable beverage producer of claim 12, wherein said lid hole cover can be adjusted to open or close said hole of said lid to any size of diameter from all the way opened to all the way closed and any diameter in between opened and closed.

14. The stackable beverage producer of claim 1, wherein said removable base is preformed so that it can be attached to said upper hopper or said lower hopper to create a separate chamber.
